(19) United States
(12) Patent Application Publication
(10) Pub. No.: US 2015/0107251 A1
(43) Pub. Date: Apr. 23, 2015

(54) POWER REGULATION AND/OR FREQUENCY REGULATION IN A SOLAR THERMAL STEAM POWER PLANT

(71) Applicant: SIEMENS AKTIENGESELLSCHAFT, MÜNCHEN (DE)

(72) Inventors: Matthias Buggert, Erlangen (DE); Wolfgang Wiesenmüller, Fürth (DE)

(21) Appl. No.: 14/383,823

(22) PCT Filed: Mar. 13, 2013
(86) PCT No.: PCT/EP2013/055118

§ 371 Date: Sep. 8, 2014

(30) Foreign Application Priority Data
Mar. 16, 2012 (DE) 10 2012 204 218.0

(51) Int. Cl. F01K 13/02; F03G 6/00

(52) U.S. Cl. CPC F01K 13/02; F03G 6/003
USPC 60/652; 60/641.8; 60/667; 60/676

(57) ABSTRACT

A method for setpoint value adjustment of a setpoint value, particularly for automatic power and/or frequency or primary and/or secondary frequency regulation, in a solar thermal steam power plant having a primary heat source that is not freely adjustable and an additional heat source and also to a solar thermal steam power plant is provided. A present power range for this solar thermal steam power plant is ascertained for at least one prescribed time during operation of the solar thermal steam power plant. This present power range is limited by an upper and a lower control range limit. For the setpoint value adjustment, a currently prescribed setpoint value for the solar thermal steam power plant is set in the present power range if the currently prescribed setpoint value is outside the present power range.

### FIELD OF TECHNOLOGY

The invention relates to a method for setpoint adjustment of a setpoint, in particular for automatic power regulation and/or frequency regulation, or primary and/or secondary control, in the case of a solar thermal steam power plant having a non-adjustable primary heat source and an additional heat source, and to a solar thermal steam power plant.

### BACKGROUND

Steam power plants in their general form are widely known, for example from http://de.wikipedia.org/wiki/Dampfkraftwerk (available on 14 Mar. 2012).

A steam power plant is a type of power plant for electrical power generation, in which a thermal energy of steam is converted in a steam turbine into kinetic energy, and is further converted in a generator into electrical energy.

In the case of such a steam power plant, the steam necessary for operation of the steam turbine is first generated in a steam boiler, from (feed) water that has normally first been purified and conditioned. Further heating of the steam in a superheater cause the temperature and specific volume of the steam to increase.

From the steam boiler, the steam flows out via pipelines into the steam turbine, where it delivers a portion of its previously absorbed energy, as kinetic energy, to the turbine. Coupled to the turbine there is a generator, which converts mechanical power into electrical power. The expanded and cooled steam then flows into the condenser, where it condenses, as a result of heat transfer to the environment, and collects as liquid water.

The water goes via condensate pumps and preheaters into a feed-water vessel, to be stored temporarily, and then, via a feed pump and preheaters, is fed back to the steam boiler, thereby creating a closed circuit.

Various types of steam power plant may be differentiated, such as, for example, coal-fired power plants, oil-fired power plants, combined gas and steam turbine plants, and also solar thermal steam power plants (in the following, referred to in short as solar thermal power plants).

Solar thermal power plants are likewise known, for example, from http://de.wikipedia.org/wiki/Sonnenwärmekraftwerk (available on 14 Mar. 2012).

A solar thermal power plant in this case is a special form of steam power plant, in which solar energy is used as a primary energy source, or heat source, for steam generation.

For this purpose, such a solar thermal power plant has two circuits—(thermally) coupled via a heat exchanger—being a primary (solar) circuit and a secondary (water-steam) circuit, i.e. it operates according to a dual circuit principle.

In the primary circuit, or solar circuit, a heat transfer medium—usually flowing through a multiplicity of solar collectors, disposed in a solar collector array—for example (heat transfer) oil, is heated therein by incident solar radiation (primary heat/energy source or primary energy/heat supply).

The heated heat transfer medium flows on through the heat exchanger, in which it transfers the absorbed thermal energy to the secondary circuit, the water-steam circuit, or to the process medium therein, i.e. to a (feed) water.

The—now cooled—heat transfer medium then flows back to the solar collectors, such that the primary circuit, or solar circuit, is closed.

The transfer of heat from the primary circuit to the secondary circuit, or the water-steam circuit, causes the (feed) water to be converted there to steam, i.e. it is heated, vaporized and superheated, and flows via pipelines to the steam turbine, in which the steam, as a result of expansion, gives off a portion of its energy, as kinetic energy, to the turbine.

The generator coupled to the turbine then converts the mechanical power into electrical power, which is fed, as electric current, into an electric power grid.

Generally, disposed beneath the turbine is the condenser, in which the steam—after expansion in the turbine—transfers most of its heat to the cooling water. During this process, the steam liquefies as a result of condensation.

The feed-water pump conveys the resultant liquid water, as feed water, back to the heat exchanger, such that the secondary circuit is also closed.

All items of information arising in a solar thermal power plant such as, for example, measurement values, process or status data, are displayed in a control station and analyzed there, usually in a central computing unit, wherein operating states of individual power plant components are displayed, analyzed, monitored, and controlled by open-loop and/or closed-loop control.

Power plant personnel can intervene in an operating sequence of the power plan via control elements, for example by opening or closing a fitting or a valve or, also, by altering a supplied fuel quantity.

A main constituent part of such a control station is a master computer, implemented on which is a block control system, a central monitoring or open-loop and/or closed-loop control unit—for example as an automation system/automation software—by means of which monitoring, open-loop control and/or closed-loop control of the solar thermal power plant can be performed.

In a deregulated electricity market, flexible load operation of power plants and facilities for frequency regulation in electric power grids are becoming increasingly important for power plant operation.

In respect of frequency regulation in electric power grids, various types of frequency regulation may be distinguished, for example a primary control and a secondary control, with or without a so-called dead band.

Since electrical energy cannot be stored on its course from the generator to the consumer, electricity generation and electricity consumption have to be in balance at every instant in the electric power grid, i.e. the amount of electrical energy generated has to be exactly the same as the amount consumed. In this case, the frequency of the electrical energy is the integrating controlled variable, and assumes the nominal value of the grid frequency as long as electricity generation and electricity consumption are in balance. The rotational speeds of the power plant generators connected to an electric power grid are synchronized with this grid frequency.

If, at a certain point in time, there is a generation deficit in the electric power grid, this deficit is first covered by energy contained in centrifugal masses of rotating machines (turbines, generators). This causes the machines to be braked, as a result of which their rotational speed, and therefore the (grid) frequency, are further reduced.

If this reduction of the grid frequency is not counteracted by appropriate power regulation or frequency regulation in the electric power grid, this would result in a total failure of the grid.

Normally, no closed-loop control interventions of any kind are performed within the so-called dead band, in the range of small frequency deviations of up to +/−0.07-0.1 Hz. The only possibility in this range is a delayed, slow correcting open-loop control for the purpose of compensating remaining differences between generation and consumption.

Larger frequency deviations, in the range of 0.1-3.0 Hz, for example caused by power plant outages and fluctuations in electricity consumption, are distributed by the primary control system to the power plants in the entire electric power grid that are participants in the primary control system. For this purpose, these power plants make available a so-called primary control reserve, i.e. a power reserve, which is delivered automatically by the participating power plants to the electric power grid, in order thereby to compensate within seconds the imbalance between generation and consumption, by regulating generation.

The primary control system thus serves to stabilize the grid frequency in the case of deviation that is as small as possible, but at a level that deviates from a specified nominal value of the grid frequency.

The secondary control system, which is linked to the primary control system, has the function of restoring the balance between the electricity generators and consumers in the electric power grid, and thereby bringing the grid frequency back to the specified nominal value of the grid frequency, e.g. 50 Hz.

For this purpose, the power plants participating in the secondary control system make available a secondary control reserve, in order to bring the grid frequency back to the nominal value of the grid frequency and restore the balance in the electric power grid.

The requesting of the primary control reserve and delivery of the primary control reserve into the electric power grid is effected automatically by the control units of the power plants participating in the primary control system (the electric power grid as such, or the frequency change in the electric power grid, requests (calls up) the primary control reserve), whereas the secondary control reserve is requested from the power plants participating in the secondary control system by a higher-order network regulator in the electric power grid—and then, in response to this request, is delivered into the electric power grid by the power plants.

The provision of frequency reserve, or primary and/or secondary control reserve, is partly, to a certain extent—determined by national regulations—mandatory for the power plants; control reserves made available by the power plants are generally remunerated to the power plants as special grid services.

Thus, for solar thermal power plants, likewise, participation in the frequency regulation system or a power control operation may also be economically attractive. Moreover, with an expansion of renewable energies (e.g. wind energy), it is expected that requirements for a regulation capability of different types of power plant will become more stringent. Thus, it is to be expected that the requirement for frequency regulation will also be imposed on solar thermal power plants in the future.

However, the operation of a solar thermal power plant has the disadvantage that, because the primary heat source is not freely adjustable, and owing to a hysteresis of the solar thermal process, the solar thermal power plant is incapable of power regulation and/or frequency regulation.

In this case, the primary heat source that is not freely adjustable is to be understood to mean that this primary heat source is subject to conditions that cannot be influenced by a power plant—and consequently—from the point of view of the power plant—it is not freely adjustable. Thus, for example, the incident solar radiation, or its primary heat supply to the heat transfer medium, is subject to more or less random, unforeseeable changes such as, for example, those caused by varying incident solar radiation, or cloud cover, with the result that such a heat source is not freely adjustable by a power plant.

Moreover, since the solar collector array generally extends over a large area, changes in the solar collector array are subject to a very considerable time lag. Consequently, a precise alteration of the generator output cannot be effected by altering a focus setting of the solar collectors, and this likewise greatly limits the capacity for power regulation and/or frequency regulation in the case of a solar thermal power plant.

Power regulation and/or frequency regulation, or primary and/or second control, or the provision of a frequency reserve, or primary and/or secondary control reserve—as desired or required—is not possible in the case of such solar thermal power plants.

In order that, nevertheless, a certain power adjustment can be achieved in the case of solar thermal power plants, an additional heat source, —being in addition to the primary heat source (in the solar circuit)—for example an additional natural-gas firing system, by means of special natural-gas boilers, may be provided in the primary circuit.

This additional heat source or, specifically, such an additional natural-gas firing system, in particular disposed in the solar circuit, directly preceding the heat transfer means, or heat exchanger, makes it possible to adjust the temperature of the heat transfer medium in the primary circuit as required, thereby enabling a greater or lesser amount electrical power to be generated in the secondary circuit.

If, in this case, heat is supplied, or reduced, by the additional heat source, for example the natural-gas firing system, according to the requirement, then, in the case of such a solar thermal power plant having a primary heat source/supply that is not freely adjustable and having an additional heat source/heat supply, the electrical power delivered by the power plant can be increased, or electrical power ramps, and a frequency regulation, or primary and/or secondary control, can be implemented to a certain extent.

The power that can be achieved—in this case, also, i.e. in the case of such a solar thermal power plant having a primary heat source—that is not freely adjustable—and an additional heat source, as also in the case of solar thermal power plants in general—is limited only by an ascertained power capability, i.e. a maximally attainable power of the power plant, subject to the status of individual power-limiting units of equipment (e.g. feed pumps in operation).

Moreover, the additional heat source in the primary circuit can also be used to keep the heat transfer medium liquid (“anti-freeze protection”).

However, one gauge of the use of this additional heat source such as, for example, the additional natural-gas firing system, is based solely on economic considerations, and such an additional heating system, or heat supply, does require additional/increased fuel costs and/or power plant costs.

Even if, in principle, such an additional heat supply does make it possible to achieve a certain power adjustment in the case of this solar thermal power plant, there remains the disadvantage that it is still not possible to foresee the range, or scope, within which the power adjustment is possible, or power regulation is thereby made possible, since the fluctuations in the case of the—non-adjustable—primary heat source, i.e. the solar energy, cannot be influenced by the power plant and occur more or less randomly.

Consequently, however, owing to the randomly occurring fluctuations in the primary heat supply, such a solar thermal power plant—having a primary heat source that is not freely adjustable and having an additional heat source—is not capable of power regulation and/or frequency regulation, or primary and/or secondary control, which—as a least negative effect—involves corresponding revenue shortfalls for the operator of the power plant.

For the purpose of accelerating power changes in the context of frequency regulation, or secondary and/or primary control, in the case of steam power plants, it is known (“Flexible Load Operation and Frequency Support for Steam Turbine Power Plants”, Wichtmann et al., VGB PowerTech July 2007, pages 49-55), to use quick-acting ancillary measures that are based on the use of energy contained in the process medium of the steam power plant, i.e. in the feed water, or steam (“thermal storage in the water-steam circuit”).

Known examples of this are throttling of a high-pressure turbine control valve, introducing of overload for the high-pressure turbine section, condensate accumulation, bypassing of high-pressure preheaters by feed water, and throttling of the bleed steam lines to the high-pressure preheaters.

However, these energy storages inherent in the process medium, or these thermal storages in the water-steam circuit, are limited, such that the control reserve thereby made available is also limited.

There is also the need to replenish such a thermal storage in the water-steam circuit once the energy storage, or thermal storage, in the water-steam circuit has been used up/emptied, and this further limits the control reserves.

### SUMMARY

The invention is based on the object of creating a method that renders possible, in particular, automatic, or automated, power regulation and/or frequency regulation, or primary and/or secondary control, in the case of a solar thermal power plant having a non-adjustable primary heat source and an additional heat source. The invention is also based on the object of creating a solar thermal power plant suitable for, in particular, automatic, or automated, power regulation and/or frequency regulation, or primary and/or secondary control.

The object is achieved by the method for setpoint adjustment of a setpoint, in particular for automatic power regulation and/or frequency regulation, in the case of a solar thermal steam power plant having a non-adjustable primary heat source and an additional heat source, and by the solar thermal power plant having the features according to the respective independent claim.

Preferred developments of the invention are also given by the dependent claims. The developments relate both to the method according to the invention and to the solar thermal power plant according to the invention. The solar thermal power plant according to the invention is suitable, in particular, for implementation of the method according to the invention or one of the developments explained in the following.

The invention and the developments described may be realized both in software and in hardware, for example with the use of a special electrical circuit.

Moreover, it is also possible for the invention or a described development to be realized by a computer-readable storage medium, on which there is stored a computer program that executes the invention or a development.

The invention and/or each described development may also be realized by a computer program product having a storage medium, on which there is stored a computer program that executes the invention and/or the development.

The invention relates to a solar thermal power plant having a primary circuit and having a second circuit that is (thermally) coupled to the primary circuit, in particular via a heat transfer means.

Provided in the primary circuit there is an additional heat source—being additional to a non-adjustable primary heat source for a primary heat supply—for the purpose of (additionally) increasing or reducing the supply of heat to a heat transfer medium, for example a (thermal) oil, circulating in the primary circuit.

According to the method for setpoint adjustment of a setpoint, it is provided by the invention that, for at least one prescribed instant during operation of the solar thermal steam power plant, a present power control range and/or frequency control range, i.e. a present power range (power (window)) is ascertained for this solar thermal steam power plant.

This present power range, or the present power control range and/or frequency control range, of the solar thermal steam power plant is delimited by a lower control range limit and by an upper control range limit.

Moreover, the present power range is determined using a present power from the present primary heat supply by the primary heat source and using a power range from the additional heat source.

In other words, the present power range ensues from the present power from the present primary heat supply by the primary heat source and, or plus, the power range of the additional heat source—or a plurality of additional heat sources.

The lower control range limit takes account of a lower power reserve, having at least one reserve component for power regulation and/or frequency regulation, or primary and/or secondary frequency regulation. The upper control range limit takes account of an upper power reserve, likewise having at least one reserve component for the power regulation and/or frequency regulation, or primary and/or secondary frequency regulation.

In the case of the setpoint adjustment, a present setpoint of the solar thermal steam power plant that is prescribed, for example, by a load dispatching center, is set in the present power range if the presently prescribed setpoint is outside the present power range.

In this case, the limits of the present power range are intended to be included in the present power range.

In other words, or expressed more simply, according to the invention, at one instant of operation of the solar thermal power plant, having a primary heat source that is not freely adjustable and an additional heat source, a present power range (power window)) is ascertained for this power plant.

This present power range is determined by the power that can be achieved by the primary heat source/supply, i.e., by solar energy, and—whereby the power range is delimited as a window by, on the one hand, the power that can be achieved by the minimum possible addition heat supply (minimum additional heat supply, or heating) and, on the other hand, the power that can be achieved by the maximum possible additional heat supply (maximum additional heat supply, or firing).

It is intended that, with this minimum and maximum possible additional heat supply, maximum possible—downward and upward—technical boundary conditions of the additional heat source are taken into account.

The minimum additional heat supply may ensue from the fact that a certain (minimum) quantity of additional heat supply is necessary to operate the additional heat source in a stable manner. Correspondingly, a maximum additional heat supply may ensue from the fact that a stable operation of the additional heat source is delimited “upwardly”.

Moreover, it is expedient to provide such an additional heat source that allows a rapid input of heat to the heat transfer medium, for example a natural-gas firing system, and/or that—within wide ranges—is controllable. In particular, a plurality of smaller additional heat sources (“small subdivision”)—instead of one large additional heat source—may be appropriate here.

For example, the additional heat supply for the heat transfer medium, or to the heat transfer medium, may be a natural-gas firing system having a corresponding special natural-gas burner, or natural-gas boiler—or, in the case of smaller subdivision—having a plurality of natural-gas burners, or natural gas boilers, or may be effected by means of such. Other additional heating systems, such as, for example, a coal-fired or oil-fired heating system, are also possible.

At the limits of this present power range, from a present primary heat supply and an additional heat supply (minimum and maximum additional heat supply), a power reserve, comprising at least one power reserve component for power regulation and/or frequency regulation, or primary and/or secondary frequency regulation, is “built in”, or taken into account, in each case.

This means that the limits of this present power range are each pushed together by this power reserve that is to be built in, or taken into account, as a result of which the present power range is reduced at the upper limit and lower limit by these two power reserves—and as a result of which, for this present power range, a reserve component is available, or ensured, for power regulation and/or frequency regulation, or primary and/or secondary frequency regulation.

The limits of the present power range in this case are to be considered as included in the range.

These limits, as delimitations, or this present power range/(power) window, as a delimitation, may then be switched through to a setpoint setter of this solar thermal power plant, that, if the presently prescribed setpoint is outside of the present power window, sets this setpoint within the present power window, or brings it into the present power window (setpoint adjustment).

In clear terms, the present setpoint, and that to be adjusted, can in this case be shifted as far as/up to the correspondingly relevant upper or lower window limit.

A more extensive shifting of the setpoint within the present power window is possible, for example, as far as into the center of the power window, but it appears expedient to move the setpoint “only” as far as the power window limit, in order thus to avoid unnecessarily large power fluctuations of the installation.

If the prescribed or adjusted setpoint of this solar thermal power plant is then within this power window, a power regulation, such as an electrical power ramp, the secondary or primary control, of this solar thermal power plant is always possible, or ensured.

Irrespective thereof, the achievable power of this solar thermal power plant is limited only by an ascertained power capability, i.e. a maximally attainable power of the solar thermal power plant, subject to the status of individual power-limiting units of equipment (e.g. feed pumps in operation).

The present power window and/or its limits may also be communicated—for information—to the load dispatching center.

If the invention, or the method according to the invention, is implemented over a time sequence, i.e. at successive instants, of a time interval, for example an operating phase or operating period of this steam power plant/solar thermal power plant, then, as the primary heat quantity, in particular of the incident solar radiation, presently available in each case is changed, the power window within which the setpoint may be located—in order to ensure the power regulation and/or frequency regulation, or primary and/or secondary frequency regulation in the case of this solar thermal power plant—merely shifts automatically upward or downward (over time).

Associated therewith is an automatic adjustment of the possible setting range of the setpoint setter.

A present setpoint that would now suddenly be above the upper limit of the power window as a result of a reduction in the primary quantity of heat, in particular in the case of, for example, the occurrence of cloud cover, and/or additional heat quantity capacity, is adjusted accordingly by the setpoint setter, i.e. it is automatically brought down concomitantly by the falling upper delimitation.

As soon as the upper delimitation shifts back upward, as a result of a change, or increase, in the primary quantity of heat, in particular, for example, incident solar radiation without cloud cover, and/or additional heat quantity capacity, and the setpoint, which had previously been brought down together with the upper power window limit, receives “space upward”, the setpoint can also be adjusted back upward, insofar as possible.

This means that the setpoint can make use of the (power) space made available to it by the upward shift of the upper power window limit and, insofar as possible, i.e. again delimited by the upwardly shifting power window limit, can shift upward in the direction of the originally prescribed setpoint located outside of the power window of that time.

This can continue to be effected until the setpoint attains the originally prescribed level, located outside of the power window of that time, or a new setpoint is prescribed that is within the present power window.

Alternatively, however, the setpoint may also first be left remaining at the level, as an upper power window limit shifts upward, until a new present setpoint is specified.

This also applies, correspondingly, to present setpoints that are suddenly located below the lower limit of the power window.

Consequently—unlike previous solutions—the solar thermal power plant, whose primary heat supply is not freely adjustable, remains capable of power regulation and/or frequency regulation in each case, i.e. in power regulation mode, and consequently capable of primary and secondary control.

The operator therefore continues to receive the corresponding remunerations. The limits of the power window, or of the present power range, may also be communicated to the load dispatching center, for information.

The solar thermal power plant according to the invention that corresponds thereto has a data processing means, in particular a programmed computing unit, in particular implemented in a block control system, set up in such a manner that the method according to the invention for setpoint adjustment of a setpoint is implemented.

Thus, the method according to the invention for setpoint adjustment of a setpoint, as also the corresponding solar thermal power plant according to the invention, provides for automated power regulation and/or frequency regulation, or primary and/or secondary frequency regulation, because in this case the prescribed or adjusted setpoint of this solar thermal power plant is then (always) within this power window, where power regulation, such as an electrical power ramp, the secondary or primary control, of this solar thermal power plant is always possible, or ensured.

The invention proves to be considerably advantageous in numerous respects.

Thus, the invention provides for an automatic, or automated, power regulation mode of the solar thermal power plant. In particular, the invention enables the solar thermal power plant to perform frequency regulation, or primary and/or secondary control of the solar thermal power plant.

Consequently, stipulated grid connection conditions can be fulfilled by a solar thermal power plant operated according to the invention. The operator of the installation also receives corresponding remunerations for the primary and/or secondary control. Preferred developments of the invention are also given by the dependent claims. The described developments relate both to the method according to the invention and to the power plant according to the invention.

In particular, it is expedient to implement the method according to the invention, or its development, in a block control system of the solar thermal power plant, which can then execute the method according to the invention and/or developments thereof—and can thus accordingly control, by open-loop and/or closed-loop control, or run, the solar thermal power plant.

It is furthermore expedient to run the solar thermal power plant, or to set the setpoints, such that the latter—in the case of an adjustment—are on/at the limit of the power window. This means that the adjustment of present setpoints located outside of the power window can be effected to the effect that they are in each case set to the value of the limit of the respective corresponding present power range.

It is also possible for setpoints located outside of the present power range to be moved further into the respective present power range, for example as far as into the center thereof.

It is only when the power window, or the ascertained window size, falls below a prescribed minimum range, for example because the power is already approaching the maximum installation power, or power capability, owing to the primary heat supply, that the installation is corrected to the actual value and a load dispatching center influence, or a primary/secondary control influence, is switched off.

In addition, this solar thermal power plant can clearly likewise be limited according to the load capability, in order to avoid an outage of the solar thermal power plant in the case of limitations by components that determine output.

According to a further preferred development, it may be provided, in particular in automated operation of the solar thermal power plant, that the presently prescribed setpoint of this power plant is brought down, in particular automatically by a setpoint setter, at least to the upper control range limit, if the presently prescribed setpoint is above the present power range. Particularly preferably, the presently prescribed setpoint may be corrected to exactly the upper limit of the present power range.

Correspondingly, it may be provided that the presently prescribed setpoint of the power plant is brought up, in particular automatically by a setpoint setter, at least to the lower control range limit, if the presently prescribed setpoint is below the present power range. Particularly preferably, the presently prescribed setpoint may be corrected to exactly the lower limit of the present power range.

Particularly preferably, according to a development, the additional heat supply is effected by a natural-gas firing system, by means of one or more corresponding natural-gas burners, or natural-gas boilers, wherein a power range, resulting from a minimum natural-gas firing and from a maximum natural-gas firing, is thereby obtained.

Consequently, it may then be further provided that the present power range is determined using the present power from the present primary heat source, plus the minimum possible power from the additional heat supply (minimum heat supply), and using the present power from the present primary heat supply, plus the maximum possible power from the additional heat supply (maximum heat supply).

The lower control range limit may also take account of an economic contribution of the additional heat source. Thus, for economic reasons, it may be appropriate to take account of a power contribution—to be determined according to economic considerations—of the additional heat source. The lower control range limit is then increased by this economic power contribution of the additional heat source, which reduces the power range window by this economic power range.

According to a preferred development, it may also be provided that the lower power reserve—in addition to taking account of the reserve for the power regulation—takes account of a further reserve for under-firing in the case of power ramps and/or a further reserve for discharging a steam accumulator and/or for “damping”.

It may also be provided that the upper power reserve—in addition to taking account of the reserve for the power regulation—takes account of a further reserve for over-firing in the case of power ramps and/or a further reserve for charging a steam accumulator and/or for “damping”.

In the case of a preferred development, the lower control range limit is determined by the present power from the primary heat supply, plus the minimum possible power from the additional heat supply, plus the economic power contribution of the additional heat source, and plus the lower power reserve.

This lower power range limit may be conveyed, or expressed, for example mathematically, as follows: present primary heat supply+minimum additional heat supply, for example minimum natural-gas firing, +economic power contribution of the additional heat source+lower power reserve, for example reserve for under-firing in the case of power ramps, power control reserve, “damping” reserve, and reserve for possible measures in the course of the primary control.

According to a further preferred development, the upper control range limit is determined by the present power from the present primary heat supply, plus the maximum possible power from the additional heat supply, and less the upper power reserve.

This upper power range limit may also be conveyed, or expressed, for example mathematically, as follows: present primary heat supply+maximum additional heat supply, for example additional natural-gas firing, —upper power reserve, for example reserve for over-firing in the case of power ramps, power control reserve, “damping” reserve, and reserve for possible measures in the course of the primary control.

In the case of a further preferred development, it is provided that the present power range of the solar thermal power plant is communicated to a setpoint setter of this steam power plant that adjusts the presently prescribed setpoint of this power plant if this setpoint is outside of the present power range, i.e. moves it into the present power range.

It may also be provided that the lower control range limit and/or the upper control range limit and/or the present power range of the solar thermal power plant are/is communicated to a load dispatching center of an electricity distribution grid, to which this solar thermal power plant is connected.

Preferably, it is also provided that, if the ascertained present power range of the solar thermal power plant is below a prescribed minimum range, the presently prescribed setpoint is corrected to an actual value, and/or a load dispatching center influence and/or a primary/secondary control influence are/is switched off.

Particularly preferably, the invention, or the setpoint adjustment according to the invention, is in each case performed for a plurality of instants, in particular for a multiplicity of instants, of a prescribed interval of time during the operation of the solar thermal power plant.

The interval of time in this case may be a prescribed period of operation of this steam power plant. The instants may constitute a time series in the interval of time.

The invention may thus be connected in, or switched on, at a prescribable instant and or a prescribable period of time, during the operation of this solar thermal power plant.

Then, when the invention has been connected in, or switched on, the solar thermal power plant that was previously, i.e. before the instant of connecting-in, run according to the presently available primary heat quantity is run in an (automatic) load sequence mode for the prescribed period of time.

It is also preferably provided to use the invention, or the setpoint adjustment according to the invention, for automatic power regulation of the solar thermal power plant. In this case, the invention, or the procedure according to the invention, may in each case implemented for a multiplicity of instants of a time series constituted by a prescribable operating period interval of this power plant.

This means that, each time one of the presently prescribed setpoints of this solar thermal power plant is outside of the respective present power range, this present setpoint is adjusted automatically to the present power range, in particular by a setpoint setter of this solar thermal power plant. The present setpoint outside of the present power range is set into the present power range, preferably to the limit thereof.

The power of the solar thermal power plant is run, or regulated, using the presently prescribed and, if necessary, adjusted setpoints.

The setpoint in this case may be prescribed by an operator of the installation, for example by a control station operator, or by a load dispatching center of the electric power grid. The setpoints may be switched through to a setpoint setter that controls the actual power of the solar thermal power plant accordingly, by open-loop/closed-loop control.

Further, it may be provided that the data processing means according to the invention is a constituent part of a block control system of the solar thermal power plant.

According to a particularly preferred development, the solar thermal power plant has just such a block control system, which is set up to implement the invention.

The frequency control capability may be further improved if the secondary circuit has at least one thermal energy storage that is used for load changes in the context of the frequency regulation.

Such a thermal energy storage—in the secondary circuit—may in this case be based on an energy storage inherent in a process medium of the secondary circuit, such as in a feed water, or steam of a water-steam circuit.

For example, throttling of a high-pressure turbine control valve, introducing of overload for the high-pressure turbine section, condensate accumulation, bypassing of high-pressure preheaters by feed water, and throttling of the bleed steam lines to the high-pressure preheaters constitute known thermal energy storages (“Flexible Load Operation and Frequency Support for Steam Turbine Power Plants”, Wichtmann et al., VGB PowerTech July 2007, pages 49-55).

Such a thermal energy storage—when the stored energy is “called up”, e.g. by changing of the throttling or build-up of the condensate accumulation—allows a power change in the secondary circuit, to a certain extent. However, the thermal energy storage empties in this case, i.e. when energy stored therein is “called up”.

In this case, it may be provided, particularly preferably, that the additional heat source is used to fill at least one thermal energy storage in the secondary circuit.

Expediently, i.e. to enable increased and rapid power adjustments of the solar thermal power plant, a plurality of such thermal energy storages may be used in the secondary circuit, each of which may be replenished using the additional heat source.

In clear terms, or expressed more simply, a no longer full thermal energy storage in the secondary circuit is filled by using the additional heat source in the primary circuit.

For this purpose, the additional heat supply to the heat transfer medium may be activated or increased by the additional heat source, for example a natural-gas burner, in the primary circuit, which—owing to the (thermal) coupling of the primary circuit to the secondary circuit—results in an additional input of energy into the process medium of the secondary circuit. This additional input of energy into the process medium of the secondary circuit may then be used for (re)filling the thermal energy storage(s) in the secondary circuit—without a change, or reduction, of an output of the solar thermal power plant as a result.

Consequently, this use of the additional heat source in the primary circuit for the replenishing of the thermal energy storage provides for a more efficient power regulation and/or frequency regulation, or primary and/or secondary frequency regulation, in the case of this solar thermal power plant, because, owing to this (re)filling of the thermal energy storage in the secondary circuit—irrespective of the delivered output of the power plant, this thermal energy storage that is “filled over and over again” is almost constantly available for power changes in the context of power regulation and/or frequency regulation, or secondary and/or primary control, in the case of the solar thermal power plant.

Also, particularly preferably, the filling of the thermal energy storage by means of the additional heat source may be performed irrespective of the fill level of the thermal energy storage.

If the fill level of the thermal energy storage falls below a certain level, it can be filled. Consequently, the thermal energy storage can always be held available at or above a prescribed fill level. In particular, the thermal energy storage can always be filled up, or kept full.

The description given hitherto of advantageous designs of the invention contains numerous features that are reproduced in the individual dependent claims, in some cases multiply combined. Persons skilled in the art, however, will also consider these features individually and combine them in appropriate, further combinations.

In particular, these features can each be combined individually and in any appropriate combination with the method according to the invention and/or with the device according to the respective independent claims.

### BRIEF DESCRIPTION

Represented in the figures is an exemplary embodiment of the invention, which is explained more fully in the following.

In the figures

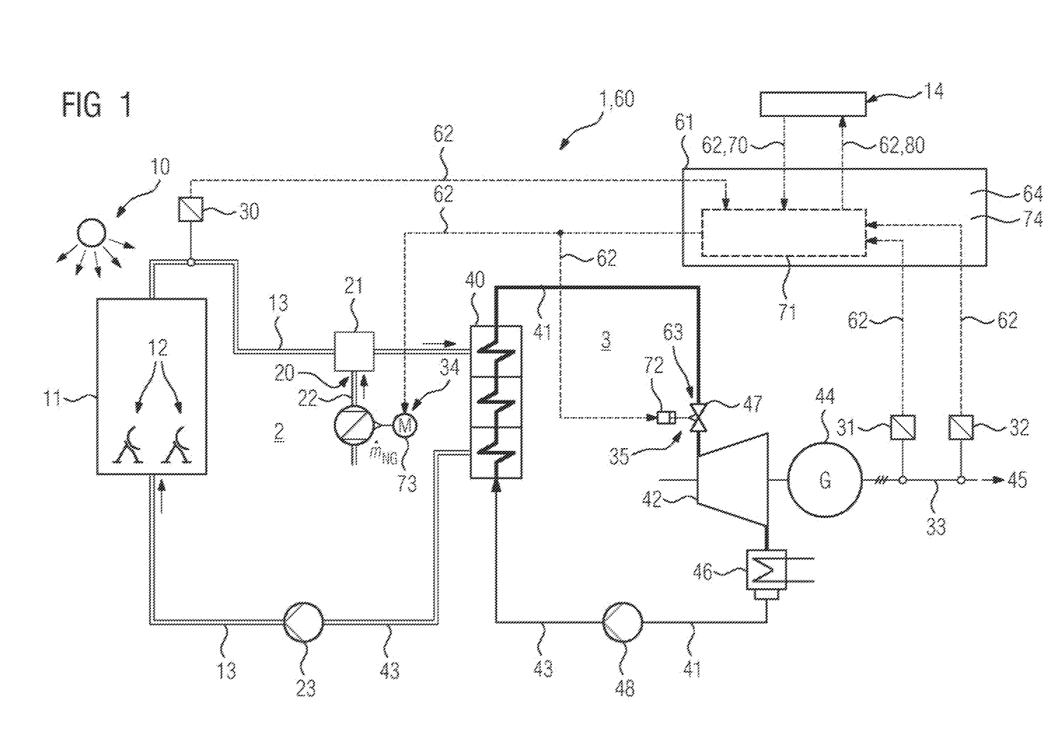

FIG. 1 shows a closed-loop control/open-loop control/installation plan of a solar thermal power plant capable of power regulation, according to an exemplary embodiment,

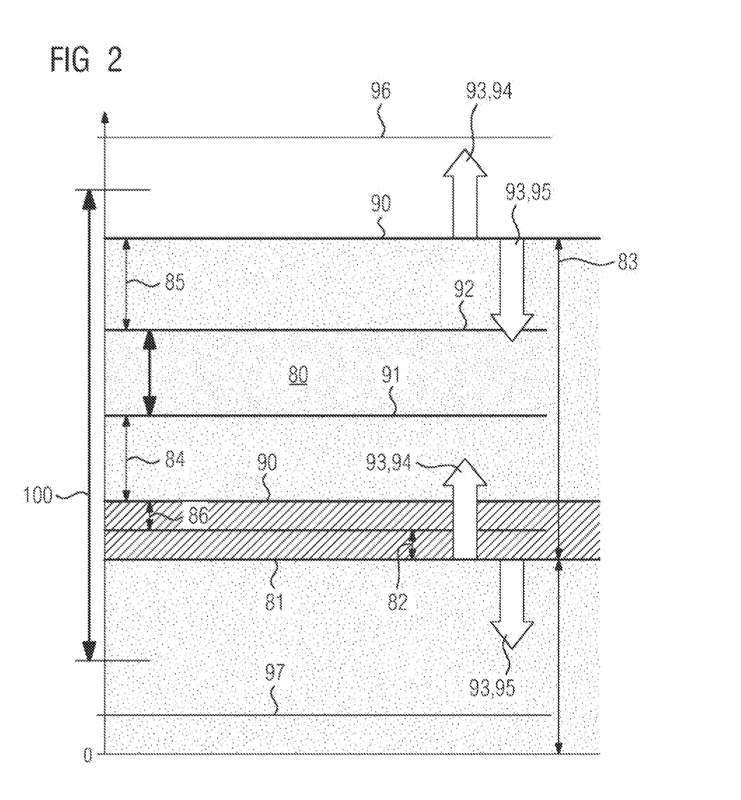

FIG. 2 shows a schematic representation of a power window of the solar thermal power plant capable of power regulation according to FIG. 1,

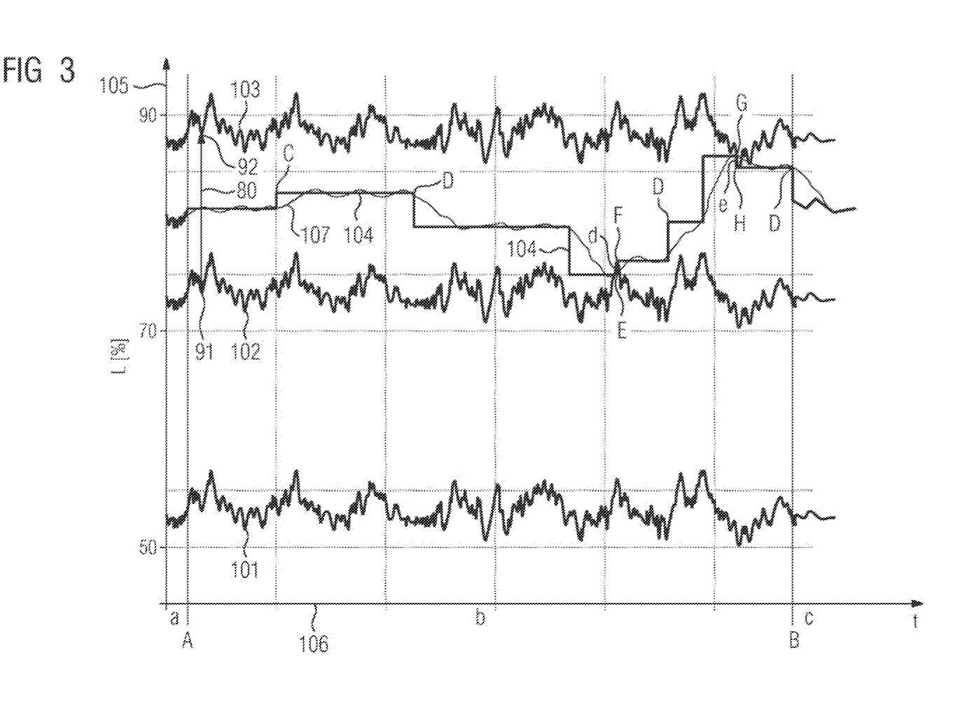

FIG. 3 shows power ranges and power responses of a solar thermal power plant in actual operating mode and in load sequence mode, according to the exemplary embodiment.

### DETAILED DESCRIPTION

### Exemplary Embodiment

### Automated Solar Thermal Power Plant Capable of Power Regulation

FIG. 1 shows a closed-loop control/open-loop control/installation plan 60 of a solar thermal power plant 1 capable of power regulation (“load setting mode”).

Unlike hitherto conventional solar thermal power plants, the power plant 1 described here—in addition to being run in the usual, known actual operating mode of the installation a, c or 72—can be run so as to be capable of automated power regulation (“load setting mode”/power sequence mode) b or 71.

The power regulation capability of this solar thermal power plant 1 in this case also includes the capability for secondary control (“secondary grid frequency control”).

All items of information arising in the solar thermal power plant 1 such as, for example, measurement values, process or status data, are displayed in a control station and analyzed there in a central computing unit 64, a block control system 61—as a central monitoring or open-loop control and/or closed-loop control element of the solar thermal power plant 1, wherein operating states of individual power plant components are displayed, analyzed, monitored, and controlled by open-loop and/or closed-loop control.

There, interventions can be made in the operating sequence of the solar thermal power plant 1, either by a control station operator, using control elements, via the block control system—as a main constituent part of the master computer—or in an automated manner—and thereby running the installation—for example by opening or closing a fitting or a valve or, also, by altering a supplied fuel quantity.

In particular, the power regulation and/or frequency regulation, or primary and/or secondary frequency regulation, and the automatic load sequence mode 71 of the solar thermal power plant 1 is controlled via the block control system 61.

This solar thermal power plant 1, also referred to in short in the following as the power plant 1, has two circuits 2, 3—(thermally) coupled via a multistage heat exchanger 40—being a primary (solar circuit) 2 and a secondary circuit (water-steam circuit) 3, i.e. it operates according to a dual circuit principle.

In the primary circuit, or solar circuit, 2, a heat transfer medium 13, in this case a (thermal) oil 13, usually flowing through a multiplicity of solar collectors 12 disposed in a solar collector array 11, is heated therein by incident solar radiation 10 (primary heat/energy source, or primary energy/heat supply, or input, primary energy/primary source 10).

The heated heat transfer medium 13 flows on through a natural-gas boiler 21, which is fired by natural gas and in which the thermal oil 13 that has undergone “primary heating” is heated 20, or can be heated, further (additional heat source/supply, additional energy/source 20).

This additional energy source 20 is used, on the one hand, to run the installation 1 in an economically optimum manner, to stabilize the power—subject to fluctuations that cannot be influenced—from the primary energy source 10 and—as described in detail in the following—to render the power plant 1 capable of frequency regulation and operation in an automatic load sequence mode 71. On the other hand, the additional heat source 20 is used to keep the thermal oil 13 liquid (“anti-freeze protection”).

After the additional heat source 20, the thermal oil 13 flows through the heat exchanger 40, where it—at least partially—transfers the thermal energy, absorbed from a primary and, if appropriate, additional heat supply 10, 20, to the secondary circuit 3, the water-steam circuit 3, or to the process medium 41 therein, i.e. to a (feed) water 41.

The heat transfer medium 13, or thermal oil 13, —now cooled—then flows—fed by a feed pump 23—back to the solar collectors 12, or to the solar array 11, such that the primary circuit 2, or solar circuit 2, is closed.

As a result of the transfer of heat from the primary circuit 2 to the secondary circuit 3, or to the water-steam circuit 3, the (feed) water 41 is converted there to steam 41, i.e. it is heated, vaporized and superheated, and flows via pipelines 43 to the steam turbine 42, in which the steam 41, as a result of expansion, gives off a portion of its energy, as kinetic energy, to the turbine 42.

The generator 44 coupled to the turbine 42 then converts the mechanical power into electrical power, which is fed 45, as electric current, into an electric power grid 33.

Disposed beneath the turbine there is a condenser 46, in which the steam 41—after expansion in the turbine 42—transfers most of its heat to cooling water. During this process, the steam 41 liquefies as a result of condensation.

A feed-water pump 48 feeds the resultant liquid water 41, as feed water 41, back to the multistage heat exchanger 40, such that the secondary circuit 3 is also closed.

Various thermal storages 63, based on an energy storage inherent in the feed water 41, or steam 41, are realized in the secondary circuit 3, i.e. in the water-steam circuit 3.

Here, for example, FIG. 1 represents such a thermal storage 63 in the form of a throttling of a high-pressure turbine control valve 47, or a high-pressure turbine control valve throttle 47.

Other thermal storages 63—not specified in greater detail—are the introducing of overload for the high-pressure turbine section, condensate accumulation, bypassing of high-pressure preheaters by feed water, and throttling of the bleed steam lines to the high-pressure preheaters.

In this case, a throttling of the high-pressure turbine control valve 63—controlled with open-loop/closed-loop control by the block control system 61—permits selective “call up” of the energy inherent in the feed water 41, or steam 41, thereby rendering possible—as part of frequency regulation—a selective modification of power in the secondary circuit 3. When energy/power has been called up from the thermal storage 63—described exemplarily here—i.e. the throttling of the high-pressure turbine control valve 47, for the required modification of power in the case of frequency regulation, this thermal storage 63, 47 must be replenished.

This is effected—likewise controlled via the block control system 61—by the additional, or increased, natural-gas 20 heating in the solar circuit 2, as a result of which additional thermal energy is input into the thermal oil 13.

Via the heat exchanger 40, this additional energy input is transferred into the secondary circuit 3, where it remains available for replenishing the used thermal storage 63, 47. The block control system 61 shifts the throttling 47 back to the original state—and the thermal storage 63, 47 has been refilled.

For this purpose, as shown by FIG. 1, in particular the output of the solar array 30, the operating status of the natural-gas heating 34, the status of the throttling 35, and the power 31 generated by the power plant 1, as well as the grid frequency 32 of the electric power grid 33, are transmitted—via corresponding line connections 62—to the block control system 61.

As additionally represented by FIG. 1, the open-loop control of the natural gas heating 20—by means of open-loop/closed-loop control of the natural-gas stream 22, 73—and the throttling of the high-pressure turbine control valve 47—by means of the open-loop/closed-loop control of the high-pressure turbine control valve throttle 47, 72—are then likewise effected by the block control system 61.

This means that the installation 1 can thus be run—by automatic prescription of the load dispatching center 14—in a load sequence mode 71 with a capability for frequency regulation, or primary and/or secondary control. For this purpose, the installation 1, or the turbine 42, is run in power regulation mode, i.e. in a modified variable-pressure mode with throttled valves.

In the case of the solar thermal power plant 1, the power that can be achieved is limited only by an ascertained power capability 96, i.e. a maximally attainable power of the power plant 1, subject to the status of individual power-limiting units of equipment (e.g. feed pumps in operation).

Operation of the Power Plant 1 in the “Load Setting Mode” 71

FIG. 2 shows a schematic representation of the power sequence mode/“load setting mode” 71, or the corresponding power range 80 of the power plant 1 for the power sequence mode b or 71.

In the power sequence mode b or 71 that is possible for the installation 1, the installation is operated in modified variable-pressure mode, with throttled valves. Corresponding power curves, or the operating characteristic, are/is represented in greater detail in FIG. 3.

As shown firstly by FIG. 2, the power range (power window/“range of adaptability”) 80 in which the power plant 1 is capable of automated power regulation, i.e. in the “load setting mode” 71, is subject to certain limitations.

The power setpoint (the setpoint) 70 of the installation 1 must be within this power window 80 in order to be capable of automated power regulation. For this purpose, the limits 90 of the power window 80 are switched through, as delimitations, to a power setpoint setter (not denoted).

The power window 80 is first delimited downwardly by the power from the presently available primary energy 81, plus the power from the minimum possible quantity of natural gas 82 that can be fired; the power window 80 is first delimited upwardly by the power from the presently available primary energy 81, plus the power from the maximum possible quantity of natural gas 83 that can be fired.

Furthermore, at the lower limit 90 of the power window 80, a natural-gas firing quantity is provided, in order to achieve the economic optimum 86. This means that the lower limit 90 of the power window 80 shifts upward by this amount—which takes account of economic boundary conditions.

In order to be capable of automated power regulation, a lower power reserve 84 and an upper power reserve 85 are additionally built in at the limits 90 of the power window 80. This means that the power window 80 is (further) reduced by this lower and upper power reserve 84, 85, respectively.

These power reserves 84, 85 ensure that the power plant 1 is capable of power regulation, provided that it is operated within these “reserve limits” 91 (lower limit of the power range/window in the “load setting mode”), 92 (upper limit of the power range/window in the “load setting mode”), i.e. the setpoints are set within these limits 91, 92.

The lower power reserve 84 is composed of a reserve for under-firing in the case of power ramps, a “damping” reserve, a reserve for discharging the steam accumulator, as well as the reserve for the power regulation (“load control”), and the reserve for the primary control; the upper power reserve 85 is composed of a reserve for over-firing in the case of power ramps, the “damping” reserve, a reserve for charging the steam accumulator, as well as the reserve for the power regulation, and the reserve for the primary control.

In accordance with a power increase or power reduction of the installation when in the “load setting mode”, the steam pressure must be increased or reduced, respectively. For this purpose, a corresponding, adequate quantity of reserve power must be made available for the respective power ramp to be run.

Likewise for the power regulation, it is necessary to hold ready a certain power reserve, which ensues from the requirements from power regulation of the turbine 42 and the secondary control.

In this case, this power window 80, within which the setpoint 70 of the installation 1 may be located, is dynamic, i.e. it shifts during the operation of the power plant 1 in dependence on the—fluctuating, or changing—available primary energy 10, 93. If more primary energy 10 is available (increased incident solar radiation), the power window 80 shifts upward 94; if less primary energy is available (cloud cover), the power window shifts downward 95.

The achievable power of the power plant 1, the “range of operation” 100, is delimited upwardly only by an ascertained power capability 96, i.e. a maximally attainable power of the power plant 1, subject to the status of individual power-limiting units of equipment (e.g. feed pumps in operation).

Downwardly, the attainable power of the installation is delimited only by a maximum (minimum) load/power 97 that is necessary, at least, for stable operation of the installation 1.

It is only when the power window 80, or the ascertained window size, falls below a prescribed minimum range, for example because the power is already approaching the maximum installation power, or power capability 96, owing to the primary heat supply 10, that the installation 1 is corrected to the actual value and a load dispatching center influence, or a primary/secondary control influence, is switched off (actual mode 84).

As shown by FIG. 1, the power plant 1 is operated by prescription—by the load dispatching center 14—of the (power) setpoint, MWel 70. From this prescribed setpoint 70, corresponding setpoints are ascertained for the natural-gas firing control 73 and the turbine control 72—and the installation 1 is regulated, or operated, according to these setpoints.

The limits 90 of the present power window 80 are also communicated to the load dispatching center 14, for information.

FIG. 3 shows, in curves, the power ranges and the operating/power characteristic of the solar thermal power plant 1 in the actual mode a, c or 74, and in the power sequence mode b or 71 (“load setting mode”).

The represented curves in this case are each given as normalized curves in [%] (axis 105) over time t (axis 106).

The curve 101 shows the characteristic of the power made available by the primary heat source/supply 10. The curve 104 shows the characteristic of the (power) setpoint of the installation 1; the curve 107 represents the actual power operation of the installation 1.

During the operating phases a and c of the installation 1, the solar thermal power plant 1 is operated—manually by the operator—in the usual actual mode 74. The setpoint 70 of the installation 1 is set according to the available power from the primary heat source/supply 10, i.e. the setpoint 70 follows the characteristic 101 of the primary energy 10, 101.

At the instant A, the power plant 1 is put into the power sequence mode b or 71, in which the installation is operated up to the instant B.

At the instant A of starting of the power sequence mode 71, the power window 80 “opens” with the lower power window limit 102 represented in FIG. 3, or 91, and the represented upper power window limit 103, or 92. At the instant A, the setpoint is moved, for instance, into the center of the power window 80.

As additionally shown by FIG. 3, as the “primary energy” 10, 101 presently available in each case changes, the power window 80, within which the setpoint 70 must be located (characteristic C)—to ensure power regulation 71 in the case of the solar thermal power plant 1—shifts upwards or downward.

Associated therewith is an automatic adjustment of the possible setting range of the setpoint setter.

As shown by FIG. 3, a present setpoint 70 that, as a result of a reduction of the primary energy 10, would now suddenly be above the upper limit 103, 92 of the power window 80 (point G), is adjusted accordingly by the setpoint setter, i.e. it is automatically brought down concomitantly by the falling upper delimitation 103 (characteristic/phase e).

As soon as the upper delimitation 103 shifts back upward, as a result of a change, or increase, in the primary energy 10 (point H), the setpoint is first left still at the level of point H, until a new present setpoint 70 is prescribed (point D).

This also applies, correspondingly, to present setpoints 70 that are suddenly located below the lower limit 102 of the power window 80.

As shown here by FIG. 3, a present setpoint 70 that, as a result of an increase in the primary energy 10, would now suddenly be below the lower limit 102, 91 of the power window 80 (point E), is adjusted accordingly by the setpoint setter, i.e. it is automatically brought up concomitantly by the rising lower delimitation 102 (characteristic/phase d).

As soon as the lower delimitation 102 shifts back downward, as a result of a change, or reduction, in the primary energy 10 (point F), the setpoint 70 is first left still at the level of point F, until a new present setpoint 70 is prescribed (point D).

At the instant B, the installation 1 exits the power sequence mode b and goes back to the actual mode c or 74. The power window 80 “closes”. The setpoint 70 again directly follows the primary energy 10.

Although the invention has been illustrated and described in greater detail by the preferred exemplary embodiments, the invention is not limited by the disclosed examples, and other variations may be deduced by persons skilled in the art, without departure from the protective scope of the invention.

1. A method for setpoint adjustment of a setpoint for automatic power regulation, in a case of a solar thermal steam power plant having a non-adjustable primary heat source and an additional heat source, the method comprising:
for at least one prescribed instant during operation of the solar thermal steam power plant, ascertaining a present power range for the solar thermal steam power plant wherein the present power range of the solar thermal steam power plant is delimited by a lower control range limit and by an upper control range limit, and the present power range is determined using a present power from the non-adjustable primary heat source and using a power range from the additional heat source,
wherein the lower control range limit takes account of a lower power reserve, having at least one reserve component for power regulation and/or frequency regulation, or primary and/or secondary frequency regulation, and wherein the upper control range limit takes account of an upper power reserve, having at least one reserve component for the power regulation and/or frequency regulation, or primary and/or secondary frequency regulation, and
in the case of the setpoint adjustment, a presently prescribed setpoint of the solar thermal steam power plant is set in the present power range if the presently prescribed setpoint is outside the present power range.

2. The method as claimed in claim 1, wherein the presently prescribed setpoint of the solar thermal steam power plant is down, at least to the upper control range limit, if the presently prescribed setpoint is above the present power range, and/or the presently prescribed setpoint of the solar thermal steam power plant is brought up, at least to the lower control range limit, if the presently prescribed setpoint is below the present power range.

3. The method as claimed in claim 1, wherein the present power range from the additional heat source, the additional heat source being a natural gas firing system, is defined by a minimum possible power from the additional heat source and by a maximum possible power from the additional heat source.

4. The method as claimed in claim 1, wherein the present power range is determined using the present power from the non-adjustable primary heat source, the non-adjustable primary heat source being solar energy, plus the minimum possible power from the additional heat source, and using the present power from the non-adjustable primary heat source, plus the maximum possible power from the additional heat source.

5. The method as claimed in claim 1, wherein the lower control range limit takes account of an economic contribution of the additional heat source for attainment of an economically efficient operation of the solar thermal power plant for the attainment of an economically efficient optimum.

6. The method as claimed in claim 1, wherein the lower power reserve in addition to taking account of the reserve for the power regulation and/or frequency or primary and/or secondary frequency regulation, takes account of a further reserve for under-firing and/or a further reserve for discharging a steam accumulator and/or for “damping”.

7. The method as claimed in claim 1, wherein the upper power reserve, in addition to taking account of the reserve for the power regulation and/or frequency, or primary and/or secondary control, takes account of a further reserve for over-firing and/or a further reserve for charging a steam accumulator and/or for “damping”.

8. The method as claimed in claim 1, wherein the lower control range limit is determined by the present power from the primary heat source, plus the minimum possible power from the additional heat source, plus an economic contribution of the additional heat source for attainment of an economically efficient operation of the solar thermal power plant, in particular for the attainment of an economically efficient optimum, and plus the lower power reserve, and/or the upper control range limit is determined by the present power from the primary heat source, plus the maximum possible power from the firing by an additional fuel, and less the upper power reserve.

9. The method as claimed in claim 1, wherein the present power range of the solar thermal power plant is communicated to a setpoint setter of the steam power plant that adjusts the presently prescribed setpoint of the solar thermal power plant if the setpoint is outside of the present power range.

10. The method as claimed claim 1, wherein, if the ascertained present power range of the solar thermal power plant falls below a prescribed minimum range, the presently prescribed setpoint is corrected to an actual value, and/or a load dispatching center influence and/or a frequency or primary and/or secondary control influence are/is switched off.

11. The method as claimed in claim 1, in each case performed for a plurality of instants of a prescribed interval of time during the operation of the solar thermal power plant.

12. The method as claimed in claim 11, wherein the prescribed interval of time is a prescribed period of operation of the solar thermal power plant, and/or the instants constitute a time series in the prescribed interval of time.

13. The method as claimed in claim 11, used for automatic power regulation of the solar thermal power plant,
wherein the method is in each case implemented for a multiplicity of instants of a time series constituted by a prescribable operating period interval of the solar thermal power plant,
wherein, each time one of the presently prescribed setpoints of the solar thermal power plant is outside of the respective present power range, the present setpoint is adjusted automatically to the present power range by a setpoint setter of the solar thermal power plant by setting to the respective relevant control range limit,
and the power of the solar thermal power plant is regulated using the presently prescribed and, if necessary, adjusted setpoints.

14. A solar thermal power plant having a primary heat source that is not freely adjustable and an additional heat source, further comprising a data processing means, in particular, a programmed computing unit set up in such a manner that the method of claim 1 is implemented.

15. The solar thermal power plant as claimed in claim 14, wherein the data processing means is a constituent part of a block control system of the solar thermal power plant.
